(19) United States
(12) Patent Application Publication
(10) Pub. No.: US 2010/0106548 A1
(43) Pub. Date: Apr. 29, 2010

(54) MANAGING MEETING CALENDAR ENTRIES

(75) Inventors: Maya Barnea, Kiriat Bialik (IL); Ksenya Kveler, Yoqneam Illit (IL); Gennady Laventman, Haifa (IL)

Correspondence Address: Ryan, Mason & Lewis, LLP, Suite 205, 1300 Post Road, Fairfield, CT, 06824, US

(73) Assignee: International Business Machines Corporation, Armonk, NY (US)

(21) Appl. No.: 12/260,163

(22) Filed: Oct. 29, 2008

(51) Int. Cl. G06Q 10/00

(52) U.S. Cl. 705/8

(57) ABSTRACT

Techniques for managing a meeting calendar entry are provided. The techniques include scheduling a meeting by sending an invitation to one or more individuals, wherein the meeting is scheduled by a primary organizer via a meeting calendar entry, defining one or more secondary organizers for the meeting, and facilitating the one or more secondary organizers to manage a meeting calendar entry for the meeting.

### FIELD OF THE INVENTION

The present invention generally relates to information technology, and, more particularly, to geographically distributed meetings.

### BACKGROUND OF THE INVENTION

Work in geographically distributed teams has become a common practice. People located in distinct buildings, cities and even countries do not necessarily need to meet face-to-face, as they can communicate effectively using electronic chats, electronic mails (e-mails) and the telephone. For example, a meeting can be initiated by a chairperson who sends the invitation and becomes its exclusive owner in a sense that there are certain actions that only he is allowed to perform, such as update invitation with notes, set up the location, etc.

Consider the following exemplary scenario. Steve, Tom and Dan are going to have a conference call. While Steve and Tom work in the same office (for example, in New York), Dan is going to participate in the call from his office in Israel. Steve (the chairperson) reserves a room in the NY office for Tom and himself and sends an invitation to the others. With existing approaches, Dan will face multiple problems. For instance, if Dan would like other people from his local team to participate in the call as well, he cannot add them to the invitee list unless he explicitly asks the chairperson to do so. Moreover, this would automatically cause the chairperson to be aware of these additional people presence in the room, which is not necessarily what Dan wants.

Also, Dan might need to reserve a room for his local team representatives, but he cannot add this room to the meeting calendar entry in the way his local co-workers will see it. Dan might also need to modify the meeting calendar entry notes in a way that only his local co-workers see, such as, for example, by attaching the presentation that they are going to show to their overseas colleagues.

Common approaches attempt to use various workarounds to overcome the above disadvantages. For example, one can reserve a room via a local room reservation system, write down the location on a piece of paper, send e-mails for communicating with the local team about room, notes towards the meeting, etc. Also, one can create an additional duplicate invitation with its own chair (Dan in the scenario above). However, in this case, two resulting meeting calendar entries are completely independent and require separate maintenance, meaning that canceling or rescheduling the original one has no impact on the local one, which must be updated accordingly by the local chair.

### SUMMARY OF THE INVENTION

Principles of the present invention provide techniques for managing meeting calendar entries. An exemplary method (which may be computer-implemented) for managing a meeting calendar entry, according to one aspect of the invention, can include steps of scheduling a meeting by sending an invitation to one or more individuals, wherein the meeting is scheduled by a primary organizer via a meeting calendar entry, defining one or more secondary organizers for the meeting, and facilitating the one or more secondary organizers to manage a meeting calendar entry for the meeting.

One or more embodiments of the invention or elements thereof can be implemented in the form of a computer product including a computer usable medium with computer usable program code for performing the method steps indicated. Furthermore, one or more embodiments of the invention or elements thereof can be implemented in the form of an apparatus or system including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include hardware module(s), software module(s), or a combination of hardware and software modules.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating a screen shot image of an exemplary meeting calendar entry, according to an embodiment of the present invention;

FIG. 2 is a flow diagram illustrating techniques for managing a meeting calendar entry, according to an embodiment of the present invention; and

FIG. 3 is a system diagram of an exemplary computer system on which at least one embodiment of the present invention can be implemented.

### DETAILED DESCRIPTION OF PREFERRED EMBODIMENTS

Principles of the present invention include effective management of calendar entries for geographically distributed meetings by defining secondary chairpersons. As a result of the disadvantageous existing approaches, an approach (such as described herein) empowering local chairpersons with an ability to use the original invitation and the respective original meeting calendar entry for local communication would be an elegant solution eliminating the need for time-consuming and disadvantageous workarounds described above.

In one or more embodiments of the invention, in an existing scheduled meeting calendar entry, each meeting invitee can become a secondary chairperson of the existing scheduled meeting. The secondary chairperson can add his or her own guests, reserve a local room for his or her guests, add comments, etc. All actions taken by the secondary chairperson can be performed via the same calendar entry of the existing scheduled meeting. Also, the local invitees are notified of the entry updates that the secondary chair performs (for example, local room changes, comments added, etc.).

Additionally, all original invitation changes (for example, cancellation, rescheduling, etc.) made by the original chairperson are automatically reflected to all participants invited by the secondary chairperson. By way of example, the original invitation can be received as an electronic mail (e-mail) in the inbox of each invitee. When the meeting is rescheduled or changed in some way (for example, room change, etc.), additional e-mail is sent to the invitees (that is, all invitees). In one or more embodiments of the invention, the e-mail client provides buttons that allow one-click incorporation of the changes into the invitee's calendar.

As such, as opposed to the disadvantageous existing approaches detailed above, the techniques described herein can make a participant of a scheduled meeting and/or conference a secondary chairperson (who can invite additional participant to the scheduled meeting and/or conference, with or without the knowledge of a primary chairperson). In contrast to existing approaches that merely allow the addition of new participants, the techniques described herein advantageously enable (via the original meeting calendar entry) an invitee to effectively become a (secondary) chairperson, and thereby providing him or her many abilities (as described herein). Additionally, one or more embodiments of the invention can use calendar tools.

The techniques described herein provide participants more control than just adding additional guests. One or more embodiments of the invention use a secondary chairperson paradigm, with which each meeting invitee can be empowered with an ability to use the original calendar meeting entry for effective communication within his or her local secondary team. A secondary chairperson is able to, for example, add his own guests, as well as update the calendar meeting entry with comments and/or attachments relevant to his guests only, etc. A secondary chairperson may also reserve a room (for example, for his guests) via an external reservation system. The secondary chairperson can put the local room number into the same original calendar entry and all of the local invitees will be aware of it. Further, if the secondary chairperson modifies the reserved room number in the calendar entry, all of the local invitees are notified automatically.

Also, as described herein, such actions are performed via the same original calendar meeting entry by that making sure that all original invitation changes (for example, cancellations, rescheduling, etc.) are automatically reflected in all participant calendars, including those of the secondary chair guests.

An exemplary embodiment of the present invention can include the following. A primary chairperson sends a meeting invitation to one or more participants with location, notes, invitee list, etc. After accepting the invitation, each invitee can edit the meeting calendar entry. A button and/or selectable option such as, for example, “Become a Secondary Chair” will be available in the meeting entry. After clicking and/or selecting lo that option, the invitee becomes a secondary chair. As a result, a new area appears in the meeting document that can look, for example, similar to the primary meeting details area (it may be implemented, for example, as a separate tab or inside the same view). The new area can include, for example, details about a local secondary team such as invitee list, location, notes, etc.

Additionally, the secondary chair can perform additional steps in a similar way to that of the primary chair and the secondary chair can perform additional steps immediately or at any time later. By way of example and not limitation, the secondary chair can perform additional steps such as add invitees, specify a reserved room number, and add one or more notes. Secondary chair invitees will be notified of any such changes or additions performed by the secondary chair.

In one or more embodiments of the invention, a primary chair can to disable secondary chair support, and a primary chair can require that all changes made by secondary chairs will be visible to him (the primary chair). For example, one or more embodiments of the invention can provide a selectable option to “allow secondary chairs” to the primary chair during the original invitation creation. If selected, another selectable option such as, for example, “Make all secondary actions visible to me” can be presented to the primary chair. The selection performed can then be stored together with the original invitation. If no secondary chairs are allowed for the meeting, the invitees will not be presented with the “Become a secondary chair” selectable option and/or button (or such an option will simply be disabled). A mail client, for example, on the invitee side can perform such functions.

If secondary chairs are allowed, but all changes and/or actions are set to be visible to the primary chair, when an invitee tries to become a secondary chair he or she will get a message (for example, a pop-up) warning that all of his or her changes will be visible to the primary chair.

People invited by the secondary chair can see a secondary meeting location in the calendar entry summary and both original and secondary meeting details when the calendar entry is opened. Also, in one or more embodiments of the invention, secondary chairs can see meeting details related to other secondary chairs.

Further, when a primary chair cancels and/or reschedules the meeting, a rescheduling note will be sent to all participants in a regular way. In one or more embodiments of the invention, such a change can be automatically propagated to all secondary invitees and/or it can be a secondary chair responsibility to do so. Moreover, one or more embodiments of the invention provide that secondary chairs can be assisted in another room reservation for the new time slot by providing a button and/or option in the reschedule note.

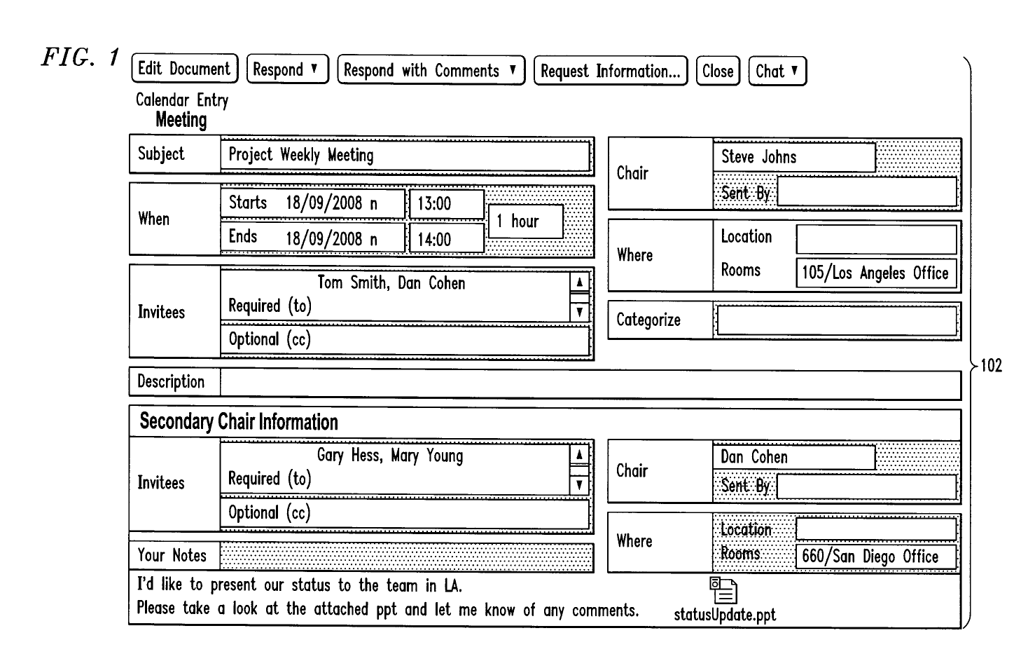

FIG. 1 is a diagram illustrating a screen shot image 102 of an exemplary meeting calendar entry, according to an embodiment of the present invention. As depicted in FIG. 1, one or more embodiments of the invention include meeting calendar entries that can provide, for example, the ability of a secondary chair/organizer to edit the calendar entry, respond to the entry, respond with additional comments, request information from one or more invitees, initiate a chat, etc. It is to be understood that FIG. 1 is merely an exemplary embodiment, and various other changes and modifications may be made or included in one or more embodiments of the invention, as described herein.

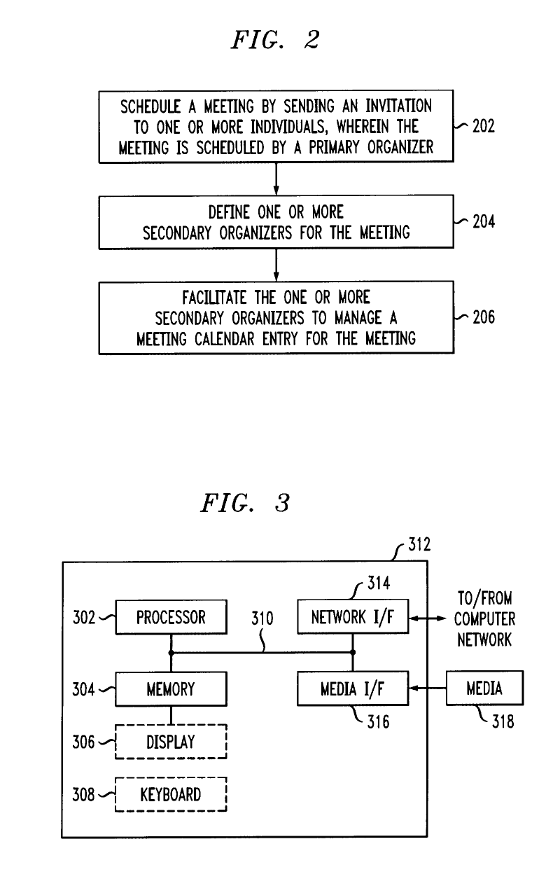

FIG. 2 is a flow diagram illustrating techniques for managing a meeting calendar entry, according to an embodiment of the present invention. Step 202 includes scheduling a meeting (for example, a geographically distributed meeting) by sending an invitation to one or more individuals, wherein the meeting is scheduled by a primary organizer (for example, a primary chairperson) via a meeting calendar entry. Step 204 includes defining one or more secondary organizers (for example, secondary chairpersons) for the meeting (that is, an invitee decides for him or herself to become a secondary organizer).

Step 206 includes facilitating the one or more secondary organizers to manage a meeting calendar entry for the meeting. Facilitating the secondary organizers to manage the meeting calendar entry can include, for example enabling the secondary organizers to invite one or more individuals to the meeting, to change a location at which one or more individuals can participate in the meeting, and wherein the one or more individuals are automatically notified of the changed location, to manage the meeting calendar entry with or without knowledge of the primary organizer and/or to update the meeting calendar entry (for example, with comments and/or attachments relevant to his guests only or to the entire meeting group), wherein one or more invitees of each secondary organizer will be automatically notified of the update.

Also, the primary organizer can require notification of a decision of one or more individuals to become a secondary organizer and/or one or more changes to the meeting calendar entry by one or more secondary organizers. Additionally, one or more embodiments of the invention include enabling an invitee to become a secondary organizer with or without knowledge of the primary organizer.

The techniques depicted in FIG. 2 can also include enabling the primary organizer to disable the secondary organizers ability to become a secondary organizer and/or manage the meeting calendar entry. Additionally, one or more embodiments of the invention include that when changes are made to the meeting calendar entry by the primary organizer, those changes are reflected to each of the individuals invited to the meeting by the secondary organizers.

Additionally, in one or more embodiments of the invention, changes made to the meeting calendar entry by a secondary organizer are reflected to each individual invited to the meeting by the secondary organizer that made the one or more changes. Also, each individual invited to the meeting by a secondary organizer see, in the meeting calendar entry, primary details as set by the primary organizer and one or more changes added by the secondary organizers that invited the individual. Further, in one or more embodiments of the invention, each secondary organizer may see, in the meeting calendar entry, meeting details related to one or more other secondary organizers.

A variety of techniques, utilizing dedicated hardware, general purpose processors, software, or a combination of the foregoing may be employed to implement the present invention. At least one embodiment of the invention can be implemented in the form of a computer product including a computer usable medium with computer usable program code for performing the method steps indicated. Furthermore, at least one embodiment of the invention can be implemented in the form of an apparatus including a memory and at least one processor that is coupled to the memory and operative to perform exemplary method steps.

At present, it is believed that the preferred implementation will make substantial use of software running on a general-purpose computer or workstation. With reference to FIG. 3, such an implementation might employ, for example, a processor 302, a memory 304, and an input and/or output interface formed, for example, by a display 306 and a keyboard 308. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like.

In addition, the phrase “input and/or output interface” as used herein, is intended to include, for example, one or more mechanisms for inputting data to the processing unit (for example, mouse), and one or more mechanisms for providing results associated with the processing unit (for example, printer). The processor 302, memory 304, and input and/or output interface such as display 306 and keyboard 308 can be interconnected, for example, via bus 310 as part of a data processing unit 312. Suitable interconnections, for example via bus 310, can also be provided to a network interface 314, such as a network card, which can be provided to interface with a computer network, and to a media interface 316, such as a diskette or CD-ROM drive, which can be provided to interface with media 318.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media 318) providing program code for use by or in connection with a computer or any instruction execution system. For the purposes of this description, a computer usable or computer readable medium can be any apparatus for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory (for example, memory 304), magnetic tape, a removable computer diskette (for example, media 318), a random access memory (RAM), a read-only memory (ROM), a rigid magnetic disk and an optical disk. Current examples of optical disks include compact disk-read only memory (CD-ROM), compact disk-read and/or write (CD-R/W) and DVD.

A data processing system suitable for storing and/or executing program code will include at least one processor 302 coupled directly or indirectly to memory elements 304 through a system bus 310. The memory elements can include local memory employed during actual execution of the program code, bulk storage, and cache memories which provide temporary storage of at least some program code in order to reduce the number of times code must be retrieved from bulk storage during execution.

Input and/or output or I/O devices (including but not limited to keyboards 308, displays 306, pointing devices, and the like) can be coupled to the system either directly (such as via bus 310) or through intervening I/O controllers (omitted for clarity).

Network adapters such as network interface 314 may also be coupled to the system to enable the data processing system to become coupled to other data processing systems or remote printers or storage devices through intervening private or public networks. Modems, cable modem and Ethernet cards are just a few of the currently available types of network adapters.

In any case, it should be understood that the components illustrated herein may be implemented in various forms of hardware, software, or combinations thereof, for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

At least one embodiment of the invention may provide one or more beneficial effects, such as, for example, in an existing meeting calendar entry, allowing each meeting invitee to become a secondary chairperson of the existing scheduled meeting.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for managing a meeting calendar entry, comprising the steps of:
scheduling a meeting by sending an invitation to one or more individuals, wherein the meeting is scheduled by a primary organizer via a meeting calendar entry;
defining one or more secondary organizers for the meeting; and
facilitating the one or more secondary organizers to manage a meeting calendar entry for the meeting.

2. The method of claim 1, wherein the meeting comprises a geographically distributed meeting.

3. The method of claim 1, wherein facilitating the one or more secondary organizers to manage the meeting calendar entry comprises enabling the one or more secondary organizers to invite one or more individuals to the meeting.

4. The method of claim 1, wherein facilitating the one or more secondary organizers to manage the meeting calendar entry comprises enabling the one or more secondary organizers to change a location at which one or more individuals can participate in the meeting, and wherein the one or more individuals are automatically notified of the changed location.

5. The method of claim 1, wherein the primary organizer requires notification of at least one of a decision of one or more individuals to become a secondary organizer, and one or more changes to the meeting calendar entry by one or more secondary organizers.

6. The method of claim 1, wherein facilitating the one or more secondary organizers to manage the meeting calendar entry comprises at least one of enabling an invitee to become a secondary organizer without knowledge of the primary organizer and facilitating the one or more secondary organizers to manage the meeting calendar entry without knowledge of the primary organizer.

7. The method of claim 1, wherein facilitating the one or more secondary organizers to manage the meeting calendar entry comprises enabling the one or more secondary organizers to update the meeting calendar entry, wherein one or more invitees of each secondary organizer will be automatically notified of the update.

8. The method of claim 1, further comprising enabling the primary organizer to disable the ability of the one or more secondary organizers to at least one of become a secondary organizer and manage the meeting calendar entry.

9. The method of claim 1, wherein one or more changes made to the meeting calendar entry by the primary organizer are reflected to each of one or more individuals invited to the meeting by the one or more secondary organizers.

10. The method of claim 1, wherein one or more changes made to the meeting calendar entry by a secondary organizer are reflected to each of one or more individuals invited to the meeting by the secondary organizer that made the one or more changes.

11. The method of claim 1, wherein each of one or more individuals invited to the meeting by the one or more secondary organizers see, in the meeting calendar entry, one or more primary details as set by the primary organizer and one or more changes added by the one or more secondary organizers that invited the individual.

12. The method of claim 1, wherein each of the one or more secondary organizers see, in the meeting calendar entry, one or more meeting details related to one or more other secondary organizers.

13. A computer program product comprising a computer readable medium having computer readable program code for managing a meeting calendar entry, said computer program product including:
computer readable program code for scheduling a meeting by sending an invitation to one or more individuals, wherein the meeting is scheduled by a primary organizer via a meeting calendar entry;
computer readable program code for defining one or more secondary organizers for the meeting; and
computer readable program code for facilitating the one or more secondary organizers to manage a meeting calendar entry for the meeting.

14. The computer program product of claim 13, wherein the computer readable code for facilitating the one or more secondary organizers to manage the meeting calendar entry comprises computer readable program code for enabling the one or more secondary organizers to invite one or more individuals to the meeting.

15. The computer program product of claim 13, wherein the computer readable code for facilitating the one or more secondary organizers to manage the meeting calendar entry comprises computer readable program code for enabling the one or more secondary organizers to change a location at which one or more individuals can participate in the meeting, and wherein the one or more individuals are automatically notified of the changed location.

16. The computer program product of claim 13, wherein the primary organizer requires notification of at least one of a decision of one or more individuals to become a secondary organizer, and one or more changes to the meeting calendar entry by one or more secondary organizers.

17. The computer program product of claim 13, wherein the computer readable code for facilitating the one or more secondary organizers to manage the meeting calendar entry comprises computer readable program code for enabling the one or more secondary organizers to update the meeting calendar entry, wherein one or more invitees of each secondary organizer will be automatically notified of the update.

18. The computer program product of claim 13, further comprising computer readable program code for enabling the primary organizer to disable the ability of the one or more secondary organizers to at least one of become a secondary organizer and manage the meeting calendar entry.

19. An apparatus for managing a meeting calendar entry, comprising:
a memory; and
at least one processor coupled to said memory and operative to:
schedule a meeting by sending an invitation to one or more individuals, wherein the meeting is scheduled by a primary organizer via a meeting calendar entry;
define one or more secondary organizers for the meeting; and
facilitate the one or more secondary organizers to manage a meeting calendar entry for the meeting.

20. The apparatus of claim 19, wherein in facilitating the one or more secondary organizers to manage the meeting calendar entry, the at least one processor coupled to said memory is further operative to enable the one or more secondary organizers to invite one or more individuals to the meeting.

21. The apparatus of claim 19, wherein in facilitating the one or more secondary organizers to manage the meeting calendar entry, the at least one processor coupled to said memory is further operative to enable the one or more secondary organizers to change a location at which one or more individuals can participate in the meeting, and wherein the one or more individuals are automatically notified of the changed location.

22. The apparatus of claim 19, wherein the primary organizer requires notification of at least one of a decision of one or more individuals to become a secondary organizer, and one or more changes to the meeting calendar entry by one or more secondary organizers.

23. The apparatus of claim 19, wherein in facilitating the one or more secondary organizers to manage the meeting calendar entry, the at least one processor coupled to said memory is further operative to enable the one or more secondary organizers to update the meeting calendar entry, wherein one or more invitees of each secondary organizer will be automatically notified of the update.

24. The apparatus of claim 19, wherein the at least one processor coupled to said memory is further operative to enable the primary organizer to disable the ability of the one or more secondary organizers to at least one of become a secondary organizer and manage the meeting calendar entry.

25. An apparatus for managing a meeting calendar entry, said apparatus comprising:
means for scheduling a meeting by sending an invitation to one or more individuals, wherein the meeting is scheduled by a primary organizer via a meeting calendar entry;
means for defining one or more secondary organizers for the meeting; and
means for facilitating the one or more secondary organizers to manage a meeting calendar entry for the meeting.
